(19) United States
(12) Patent Application Publication
(10) Pub. No.: US 2025/0027538 A1
(43) Pub. Date: Jan. 23, 2025

(54) BEARING CAGE FOR A ROLLER BEARING

(71) Applicant: AKTIEBOLAGET SKF, GOTEBORG (SE)

(72) Inventor: Volker WENDT, Üchtelhausen/Zell (DE)

(21) Appl. No.: 18/768,391

(22) Filed: Jul. 10, 2024

(30) Foreign Application Priority Data
Jul. 19, 2023 (DE) 102023206867.2

(51) Int. Cl. F16C 33/46; F16C 19/36

(52) U.S. Cl. CPC F16C 33/467; F16C 19/364

(57) ABSTRACT

A bearing cage includes a first ring element having a first diameter, a second ring element having a second diameter, and a plurality of bridges connecting the first ring element to the second ring element such that the first ring element and the second ring element and the plurality of bridges form a plurality of pockets configured to receive at least one rolling body. An outer edge region of the first ring element and/or an inner edge region of the first ring element includes at least one recess configured to increase a radially flexibility of the first ring element.

### CROSS-REFERENCE

This application claims priority to German patent application no. 10 2023 206 867.2 filed on Jul. 19, 2024, the contents of which are fully incorporated herein by reference.

### TECHNOLOGICAL FIELD

The present disclosure is directed to a bearing cage for a roller bearing having increased flexibility.

### BACKGROUND

Cages for tapered roller bearings, which are used for example in bearing units for a wheel bearing of a vehicle, generally have two ring elements which are connected together via a plurality of bridges, wherein the ring elements and the bridges form pockets which are designed to guide and retain the tapered rollers. The bearing units generally comprise an outer ring and an inner ring, wherein the inner ring is provided on an axial inner end with a retaining flange which is configured to retain the rolling bodies in the raceway. Normally, a clip ring region, in which both inner rings are held together via a clip ring, is located adjacent to this retaining flange. In order to mount the cage provided with the rollers, however, it can be necessary to push the cage over the clip ring region and the retaining flange so that the cage comes to rest in front of the retaining flange. However, bearing cages have only a limited radial flexibility/expandability-even when they are produced from glass fiber-reinforced plastics.

The radial height, over which the bearing cage provided with the rollers has to be pushed, is firstly determined by the radial height of the clamping ring region and the retaining flange and secondly by the radial material thickness of the inner ring in the region of the raceway. Depending on the design of the bearing unit, it can be necessary that the material thickness of this region does not fall below a specific value since, for example, the inner ring is configured as a two-part ring in which the two ring parts are positively connected together by means of a clamping ring, wherein the clamping ring is received in a groove which is formed in the region of the inner ring in which the retaining flange is also located.

For example, a diameter of the rollers can be increased in order to increase the load rating of the bearing. So that the larger rollers can be inserted together with the cage into the bearing, however, in some circumstances it is necessary to reduce the aforementioned radial height over which the bearing cages provided with rollers has to be pushed. To this end, the material thickness of the raceway can be slightly reduced, but not the radial diameter in the region of the clamping ring and the retaining flange, resulting in a higher step relative to the raceway, which cannot be overcome by a known cage which is dimensioned for positioning the rollers on the raceway. In other words, maintaining the material thickness counteracts an increase in a load-bearing capacity of the bearing when a radial height which has to be overcome, and which is determined by the flexibility of the cage, has to be maintained.

### SUMMARY

It is thus an aspect of the present disclosure to provide a bearing cage for a roller bearing which permits an increase in the load-bearing capacity of a bearing.

A bearing cage for a roller bearing, in particular for a tapered roller bearing, is described hereinafter. The bearing cage has at least one first ring element with a first diameter and at least one second ring element with a second diameter which are connected to one another via a plurality of bridges. The ring elements and the bridges form pockets which are designed to guide and retain the rolling bodies. The second diameter can be, in particular, greater than the first diameter. Alternatively, the second diameter can also be equal to the first diameter. The roller bearing can have an outer ring and an inner ring, wherein the outer ring and the inner ring in each case have raceways on which the rolling bodies can roll. Preferably, the inner ring region is configured in two parts, wherein the two inner ring parts are connected together by means of a clamping ring. To this end, in particular, it is possible to provide a groove on a radial inner face of the inner ring part, the clamping ring being able to be inserted therein. Moreover, the bearing cage can be manufactured from a plastic material, in particular from a fiber-reinforced plastic material. For example, the bearing cage can be manufactured from a fiber-reinforced polyamide PA 66.

In order to design the bearing cage in a flexible manner on at least one ring element side in the radial diameter, so that the rolling bodies inserted into the cage can be pulled over a higher step between the radial outer diameter of an inner ring onto the raceway which is located lower than normal, the first ring element has, in an outer edge region and/or in an inner edge region, at least one first recess which is configured to increase a radial flexibility and/or expandability of the first ring element so that the diameter of the first ring element can be changed in a reversible manner. For example, the at least one recess can be configured in a radial and/or axial edge region. In particular, the diameter of the first ring element can be changed in a resilient manner. In other words, the diameter can return to its original size after it has been pulled over the step. As a result, larger rolling bodies could be inserted in the interior of the bearing, said larger rolling bodies increasing the load-bearing capacity of the bearing while the narrow design of the bearing is maintained.

According to a preferred embodiment, the first ring element has at least one second recess which is configured in an edge region which opposes the edge region in which the at least one first recess is configured. For example, when the at least one first recess is provided in a radially external region of the ring element, the at least one second recess can be provided in a radially internal region of the first ring element and vice versa. Moreover, when the at least one first recess is provided in an axially external region of the ring element, the at least one second recess can be provided in an axially internal region of the first ring element and vice versa. In particular, the at least one first recess and the at least one second recess can be of U-shaped configuration. The radial flexibility of the first ring clement can be further increased by the first and second recesses which run in different radial directions.

In a case in which the at least one first recess is provided in a radially external region and/or in a radially internal region of the first ring element, the at least one first recess can extend in the axial direction through the first ring element. Alternatively, in a case in which the at least one first recess is provided in an axially external region and/or in an axially internal region of the first ring element, the at least one first recess can extend in the radial direction through the first ring element. In particular, the at least one recess can be configured as a radial incision which extends over the entire axial extent of the first ring clement or the entire radial extent of the first ring element. This permits the flexibility of the first ring element to be increased further. In particular, a plurality of recesses can be provided adjacent to one another, so that the recesses in the first ring element form a type of wave-shaped pattern or meandering spring structure with radial slots or with axial slots.

Preferably, a depth of the at least one first recess and a depth of the at least one second recess overlap. In other words, according to the direction in which the at least one recess is formed, both the at least one first recess and the at least one second recess extend in the radial direction or the axial direction at least over half the thickness of the first ring element in this direction. This permits the rigidity of the first ring element to be reduced to a certain degree, whereby the diameter of the first ring element can be more easily enlarged.

Moreover, the at least one first recess and the at least one second recess can be arranged adjacent to one another over the circumference. For example, the at least one first recess and the at least one second recess can be arranged as a group. Moreover, more than one first recess can be arranged as a group with a second recess, or more than one second recess can be arranged as a group with a first recess. In particular, two first recesses and one second recess can be provided, wherein the second recess is arranged between the two first recesses in the circumferential direction. As the recesses are provided alternately from the outside and the inside in the first ring element of the cage, the flexibility of the ring element can be increased even further, so that the rolling bodies can be pushed more easily over the obstacle of the clamping ring region or the retaining flange and, when the rolling bodies reach the raceway, the ring element can spring back again to the original diameter in order to bring the rolling bodies in the bearing into the actual raceway region so that the cage can perform its roller guidance function in the original sense.

Preferably, the at least one first recess and the at least one second recess are configured in the region of a pocket. A rigidity of the first ring element is lower in the region of the pocket, i.e. between two bridges, so that a sufficient increase in the flexibility can be achieved by the recess or the recesses.

According to a further preferred embodiment, the at least one recess is configured as a tapering notch which extends in the axial direction through the first ring element. In particular, the notch can be V-shaped. When the bearing cage is inserted in a tapered roller bearing, it is preferred that the notch is configured in a region of the bridge in the vicinity of the small roller end. Advantageously, the notch can extend in the axial direction beyond the ring element to the bridge or simply be formed on the bridge. The notch makes it possible to retain the first ring element of the cage as rigidly as in a cage without a recess, but to make the cage bridges more flexible, in particular in the region of the small end of a rolling body.

Preferably, the notch extends in the axial direction at least as far as a contact point of the rolling body with the bridge. This makes it possible to reduce a wall thickness of the bridge radially outwardly from the contact point, whereby a contact surface of the bridge with the rolling body has a lower rigidity so that the end of the rolling body located in this region can slip to a certain degree radially upwardly, by the bridges being distorted slightly. Alternatively or additionally, a central axially running slot can also be provided in at least one bridge, whereby a rigidity of the contact surface of the bridge with the rolling body can be reduced.

Preferably, the first ring element is provided with a plurality of recesses which are arranged so as to be uniformly distributed over the circumference. For example, the first ring element can have both a notch in the region of the bridges and also groups of first and second recesses in the region of the pocket. This makes it possible to increase both the flexibility of the first ring element and also to reduce the rigidity of the bridge in the region of the contact surface with the rolling body so that the cage provided with the rolling bodies can be pushed more easily over the clip ring region and retaining flange.

Further advantages and advantageous embodiments are specified in the description, the drawings and the claims. In particular, the combinations of features specified in the description and in the drawings are purely by way of example, so that the features can also be present individually or combined differently.

### BRIEF DESCRIPTION OF THE DRAWINGS

The invention is to be described in more detail hereinafter with reference to exemplary embodiments shown in the drawings. The exemplary embodiments and the combinations shown in the exemplary embodiments are purely by way of example and are not intended to specify the protected scope of the invention. This is solely defined by the dependent claims.

FIG. 1 is a perspective view of a bearing cage according to a first embodiment of the present disclosure.

FIG. 2 is a perspective view of a bearing cage according to a second embodiment of the present disclosure.

FIG. 3 is a perspective view of a bearing cage according to a third embodiment of the present disclosure.

### DETAILED DESCRIPTION

Elements which are the same or functionally the same are provided hereinafter with the same reference signs.

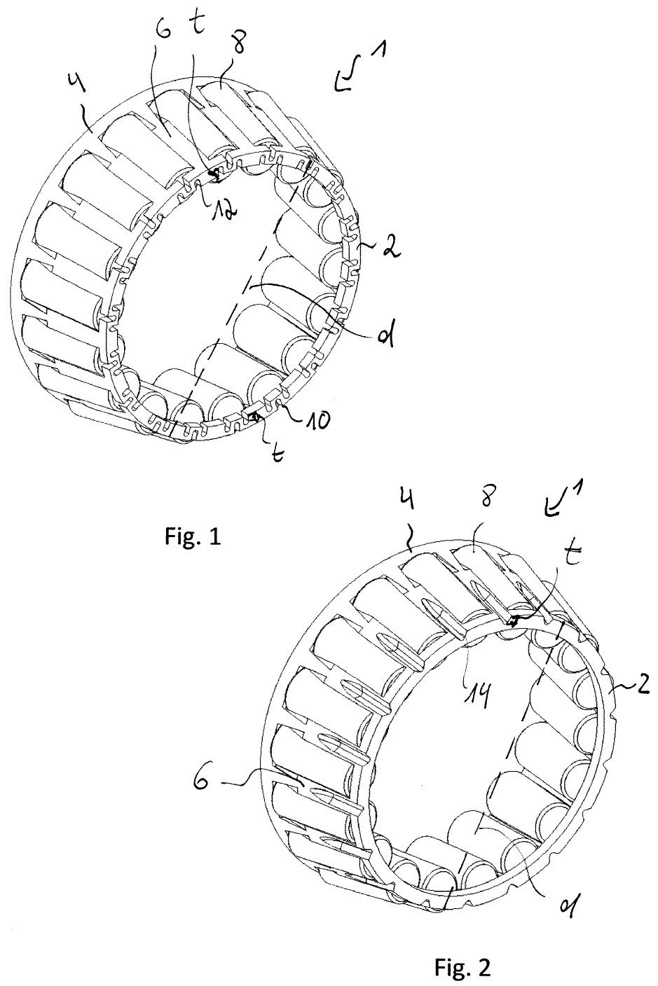

FIG. 1 shows a bearing cage 1 for roller bearings (not shown) according to a first embodiment. In FIG. 1, the roller bearing is a tapered roller bearing which can be used, for example, in a bearing unit for a wheel bearing arrangement.

The bearing cage has at least one first ring element 2 with a first diameter d and at least one second ring element 4 with a second diameter which are connected together via a plurality of bridges 6. The ring elements 2, 4 and the bridges 6 form pockets in which a rolling body 8, in particular a tapered roller, is received in each case. Since in FIG. 1 a tapered roller bearing is shown, the first diameter d of the first ring element 2 is smaller than the second diameter of the second ring element 4. Thus the first ring element can also be denoted as the small ring element. In use, the first ring element is located in the axially internal region of the roller bearing.

In the bearing cage 1, shown in FIG. 1, the first ring element 2 has a plurality of first recesses 10 which are provided in a radially external region of the first ring element 2 and a plurality of second recesses 12 which are provided in a radially internal region of the first ring element 2. As can be seen in FIG. 1, the first recesses 10 and the second recesses 12 are arranged in groups, wherein one group includes a first recess 10 and two second recesses 12. In the circumferential direction, the first recess is located between the two second recesses. The groups of recesses are provided in FIG. 1 in the region of the pocket, i.e. between two bridges 6. Naturally, it is also possible to provide only first recesses 10 or only second recesses 12 or groups of recesses which include a first and a second recess 10, 12 or more than three recesses 10, 12. Preferably, the groups or the recesses 10, 12 are arranged so as to be uniformly distributed over the circumference.

The recesses 10, 12 extend in the axial direction through the first ring element 2 and are configured, for example, as U-shaped radial incisions which extend over the entire axial extent of the first ring element 2. The radial depth of the first and second recess 10, 12 is selected such that the radial depth of the first recesses 10 and the radial depth of the second recesses 12 overlap. In other words, both the first recess 10 and the second recess 12 extend in the radial direction over at least half of the radial extent of the first ring element 2.

The recesses 10, 12 have the advantage, in particular, that they make it possible to change the diameter d of the first ring element 2 in a resilient manner, whereby the first ring element 2 can be pulled over a step formed on the inner ring, which for example can be a retaining flange, and can then still return back to its original size. As a result, larger rolling bodies can be inserted in the interior of the bearing, the larger rolling bodies increasing the load-bearing capacity of the bearing while the compact design of the bearing is maintained.

Alternatively, the recesses 10, 12 can also be designed to extend in the axial direction instead of radially, as shown in FIG. 1. In this case, recesses which are configured in the first ring element from the axial internal direction, i.e. from the roller pocket, alternate with recesses which are configured from the axial external direction, i.e. from the front face of the first ring element 2, in the first ring element 2. The desired flexibility of the ring element 2 can also be achieved by such a spring structure.

FIG. 2 shows a bearing cage 1 for roller bearings (not shown) according to a second embodiment. The bearing cage of FIG. 2 differs from the bearing cage 1 of FIG. 1 in that tapering notches 14 are configured instead of the recesses 10, 12. The notches 14 can be V- shaped, for example. As can be seen in FIG. 2, the notches 14 extend in the axial direction through the first ring element 2 and beyond the ring element 2 into the bridge 6. Alternatively, the notch 4 can also be simply formed on the bridge 6. In the axial direction, the notches 14 extend at least as far as a contact point of the roller bearing 8 with the bridge 6.

The notches 14 make it possible to keep the first ring element 2 of the cage 1 sufficiently rigid, as in a cage without a recess, but to make the cage bridges 6 more flexible in the region of an end of a rolling body 8. The axial extension of the notches 14 beyond the ring element 2 to the bridge 6 enables the wall thickness of the bridge 6 to be reduced radially outwardly from the contact point, whereby a contact surface of the bridge 6 with the rolling body 8 has a lower rigidity so that the end of the rolling body 8 located in this region can slip to a certain degree radially upwardly when the cage 1 is pulled over the retaining flange.

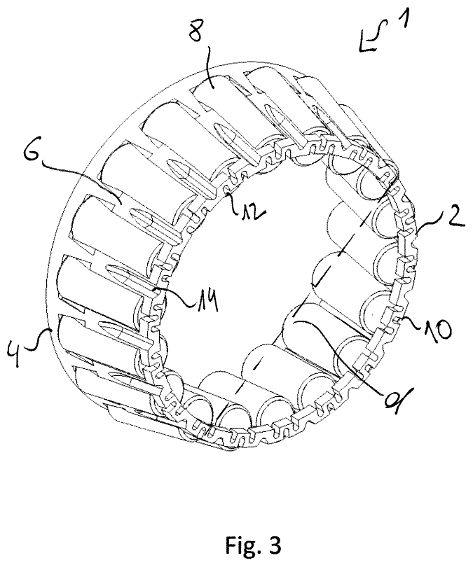

FIG. 3 shows a bearing cage 1 for roller bearings (not shown) according to a third embodiment. The bearing cage of FIG. 2 differs from the bearing cage 1 of FIG. 2 in that in addition to the notches 14 it has also the recesses 10, 12, shown in FIG. 1. This makes it possible to increase both the flexibility of the first ring element 2 due to the recesses 10, 12 and to reduce the rigidity of the bridge 6 in the region of the contact surface with the rolling bodies 8 so that the cage 1 provided with the rolling bodies can be pushed more easily over the retaining flange.

In summary, a bearing cage 1 is provided which makes it possible to increase a load-bearing capacity of the bearing, in which a diameter of the inserted rolling bodies 8 can be increased, while a bearing height is still maintained. This is achieved by the axially internal ring element 2 of the bearing cage 1 being provided with recesses 10, 12, which increase a flexibility of the ring element 2, and/or being provided with notches 14, which reduce a rigidity of the bridges in the region of the ring element 2, so that during the assembly of the rolling body 8 and cage 1 the rolling bodies can overcome the retaining flange on the inner ring.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bearing cages.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### LIST OF REFERENCE SIGNS

1 Bearing cage
2 First ring clement
4 Second ring clement
6 Bridge
8 Rolling body
10 First recess
12 Second recess
14 Notch
d Diameter
t Radial depth

What is claimed is:

1. A bearing cage comprising:
a first ring element having a first diameter,
a second ring element having a second diameter, and
a plurality of bridges connecting the first ring element to the second ring element such that the first ring element and the second ring element and the plurality of bridges form a plurality of pockets configured to receive at least one rolling body,
wherein an outer edge region of the first ring element and/or an inner edge region of the first ring element includes at least one recess configured to increase a radially flexibility of the first ring element.

2. The bearing cage according to claim 1,
wherein the first diameter is less than the second diameter.

3. The bearing cage according to claim 2,
wherein the at least one recess comprises at least one first recess and at least one second recess,
wherein the at least one first recess is located in the inner edge region, and
wherein the at least one second recess is located in the outer edge region.

4. The bearing cage according to claim 3,
wherein the outer edge region is a radially outer edge region and the inner edge region is a radially inner edge region, and
wherein the at least one recess extends axially through the first ring element.

5. The bearing cage according to claim 4,
wherein the first ring has a radial thickness, and
wherein a radial depth of the at least one recess is greater than one half of the radial thickness.

6. The bearing cage according to claim 5,
wherein the at least one first recess is circumferentially adjacent to the at least one second recess.

7. The bearing cage according to claim 5,
wherein the at least one first recess and the at least one second recess are located axially outward of one of the plurality of pockets.

8. The bearing cage according to claim 4,
wherein the at least one recess is U-shaped.

9. The bearing cage according claim 2,
wherein the at least one recess is at least one notch extending axially through the first ring element.

10. The bearing cage according to claim 8,
wherein the at least one notch extends into one of the plurality of bridges.

11. The bearing cage according to claim 1,
wherein the at least one first recess comprises a plurality of circumferentially spaced recesses.

12. The bearing cage according to claim 2,
wherein the at least one recess comprises a plurality of first recesses in a radially inner edge of the first ring and a plurality of second recesses in a radially outer edge of the first ring,
wherein a set of three of the at least one recess is axially aligned with each of the plurality of pockets, and
wherein each set of three of the at least one recess comprises one of the second recesses extending radially between two of the first recesses.

13. The bearing cage according to claim 12,
wherein the at least one recess comprises a plurality of notches each aligned with one of the plurality of bridges and extending from an axial edge of the first ring axially through the first ring and into the respective bridge.

14. The bearing cage according to claim 2,
wherein the at least one recess comprises a plurality of notches cach aligned with one of the plurality of bridges and extending from an axial edge of the first ring axially through the first ring and into the respective bridge.
